(19) United States
(12) Patent Application Publication
(10) Pub. No.: US 2020/0240505 A1
(43) Pub. Date: Jul. 30, 2020

(54) CO-MOLDED SPROCKET

(71) Applicant: BorgWarner Inc., Auburn Hills, MI (US)

(72) Inventor: Fabio MAGNI, Monza (IT)

(21) Appl. No.: 16/633,209

(22) PCT Filed: Jul. 24, 2017
(86) PCT No.: PCT/US2017/043438

§ 371 Date: Jan. 23, 2020

(51) Int. Cl. F16H 55/30; B62M 9/12

(52) U.S. Cl. CPC F16H 55/30; B62M 9/105; B62M 9/12

(57) ABSTRACT

A sprocket assembly includes a sprocket body preferably made of aluminum and at least one sprocket preferably made of steel. The sprocket assembly may include one, two, three, or more than three sprockets assembled around a central axis in the sprocket body. The sprockets have an internal design shaped to transfer the torque and the teeth on the sprocket transfer the torque to a chain or toothed belt. The steel sprockets are preferably co-molded with the aluminum sprocket body. In some embodiments, the sprocket assembly also includes at least one steel insert for each steel sprocket.

### BACKGROUND OF THE INVENTION

### Field of the Invention

The invention pertains to the field of sprockets. More particularly, the invention pertains to a co-molded sprocket with an aluminum body and sprocket teeth made of steel.

### Description of Related Art

Chain and sprocket systems are often used in automotive engine systems to transmit rotational forces between shafts. For example, a sprocket on a driven shaft may be connected via a chain to a sprocket on an idler shaft. In such a chain and sprocket system, rotation of the driven shaft and driven sprocket will cause the rotation of the idler shaft and idler sprocket via the chain. In an automotive engine system, sprockets on the crankshaft may be used, for example, to drive one or more cam shaft sprockets.

The chains used in chain and sprocket systems typically comprise a plurality of intermeshing link plates connected with pins or rollers. The sprockets typically comprise a circular plate having a plurality of teeth disposed around the circumference thereof. Located between adjacent teeth are roots having generally arcuate or semi-circular profiles for receiving the pins or rollers of the chain. Each root has a root radius, defined as the distance from the center of the sprocket to a point on the root closest to the sprocket center. The sprocket roots and/or teeth are also associated with a pitch radius, which is the distance from the center of the sprocket to a pin axis, which is part of a chain joint when the chain is seated on the sprocket.

### SUMMARY OF THE INVENTION

A sprocket assembly includes a sprocket body preferably made of aluminum and at least one sprocket preferably made of steel. The sprocket assembly may include one, two, three, or more than three sprockets assembled around a central axis in the sprocket body. The sprockets have an internal design shaped to transfer the torque and the teeth on the sprocket transfer the torque to the chain. The steel sprockets are preferably co-molded with the aluminum sprocket body.

In one embodiment, a sprocket assembly for engaging a chain or a toothed belt comprises a sprocket body forming a bore extending from a first end of the sprocket body to a second end of the sprocket body, the sprocket body having a rotational center axis extending through the bore, and at least one sprocket member co-molded with an outer circumference of the sprocket body, positioned to rotate around the rotational center axis extending through the bore, wherein the sprocket member comprises an annular body with a plurality of teeth along an outer circumference of the sprocket member to engage with the chain or toothed belt.

In another embodiment, a sprocket assembly for engaging a chain or a toothed belt comprises a sprocket body and at least three sprocket members. The sprocket body forms a bore extending from a first end of the sprocket body to a second end of the sprocket body. The sprocket body has a rotational center axis extending through the bore. The sprocket body comprises three steps, each of the steps being formed on an outer circumference of the sprocket body and comprising a flat portion connected to a transition portion, and each flat portion of the steps having a different outer circumference. The first sprocket member is positioned to rotate around the rotational center axis, and comprises a first annular body with a first plurality of teeth along a first outer circumference of the first sprocket member to engage with the chain or toothed belt. The first sprocket member is co-molded into a first flat portion of a first step of the sprocket body, such that the first annular body of the first sprocket member is integrally joined to the sprocket body and at least the first plurality of teeth of the first sprocket member are external to the sprocket body. The second sprocket member is positioned to rotate around the rotational center axis, and comprises a second annular body with a second plurality of teeth along a second outer circumference of the second sprocket member to engage with the chain or toothed belt. The second sprocket member is co-molded into a second flat portion of a second step of the sprocket body, such that the second annular body of the second sprocket member is integrally joined to the sprocket body and at least the second plurality of teeth of the second sprocket member are external to the sprocket body. The third sprocket member is positioned to rotate around the rotational center axis, and comprises a third annular body with a third plurality of teeth along a third outer circumference of the third sprocket member to engage with the chain or toothed belt. The third sprocket member is co-molded into a third flat portion of a third step of the sprocket body, such that the third annular body of the third sprocket member is integrally joined to the sprocket body and at least the third plurality of teeth of the third sprocket member are external to the sprocket body.

In another embodiment, a method of making a sprocket assembly comprising an aluminum sprocket body forming a bore extending from a first end of the sprocket body to a second end of the sprocket body, the sprocket body having a rotational center axis extending through the bore, and at least one steel sprocket member co-molded with an outer circumference the sprocket body, positioned to rotate around the rotational center axis, where the sprocket member comprises an annular body with a plurality of teeth along an outer circumference of the sprocket member to engage with the chain or toothed belt, includes the steps of manufacturing the steel sprocket member, positioning the steel sprocket member in a mold for the aluminum sprocket body, and molding the aluminum sprocket body to the steel sprocket member.

In yet another embodiment, a sprocket configured to engage with a chain or toothed belt comprises an annular body having an inner circumference and an outer circumference, a plurality of teeth spaced along the outer circumference and a plurality of holes spaced evenly within the annular body. The inner circumference of the sprocket comprises a plurality of semi-circular protrusions evenly spaced apart from each other and extending away from the inner circumference and towards the plurality of teeth on the outer circumference.

### BRIEF DESCRIPTION OF THE DRAWINGS

FIG. 1 shows a perspective view of a sprocket assembly in an embodiment of the present invention.

FIG. 2A shows another perspective view of the sprocket assembly.

FIG. 2B shows a top down view of the sprocket assembly.

FIG. 2C shows a side view of the sprocket assembly.

FIG. 2D shows a cross-sectional side view of the sprocket assembly.

FIG. 3A shows a schematic side view of the sprocket body after co-molding, with the location of the bore depicted with dashed lines.

FIG. 3B shows a schematic perspective view of the sprocket body after co-molding.

FIG. 4A shows a top view of a sprocket assembly with steel inserts.

FIG. 4B shows a perspective view of the sprocket assembly of FIG. 4A.

FIG. 4C shows a cross-sectional view along lines 4C-4C of FIG. 4A.

FIG. 4D shows a cross-sectional view of alternate embodiment.

FIG. 5A shows a top down view of a steel insert.

FIG. 5B shows a side view of the steel insert of FIG. 5A.

FIG. 5C shows a cross-sectional view along lines 5C-5C of FIG. 5A.

FIG. 5D shows a perspective view of the steel insert of FIG. 5A.

FIG. 6A shows a top down view of a sprocket assembly with a single sprocket member.

FIG. 6B shows a side view of the sprocket assembly of FIG. 6A.

FIG. 6C shows a perspective view of the sprocket assembly of FIG. 6A.

FIG. 6D shows another perspective view of the sprocket assembly of FIG. 6A.

FIG. 7A shows a top down view of a sprocket assembly with five sprocket members.

FIG. 7B shows a side view of the sprocket assembly of FIG. 7A.

FIG. 7C shows a perspective view of the sprocket assembly of FIG. 7A.

FIG. 7D shows another perspective view of the sprocket assembly of FIG. 7A.

FIG. 8A shows a sprocket in an embodiment of the present invention.

FIG. 8B shows a perspective view of the sprocket of FIG. 8A.

FIG. 9 shows a method of making the sprocket assembly in an embodiment of the present invention.

### DETAILED DESCRIPTION OF THE INVENTION

A sprocket assembly includes a sprocket body preferably made of aluminum and one or more sprockets preferably made of steel. The steel sprockets are molded into a single aluminum sprocket body. The resulting system is lightweight and provides improved wear resistance. This invention allows one to use the same steel sprockets in different combinations depending upon the application.

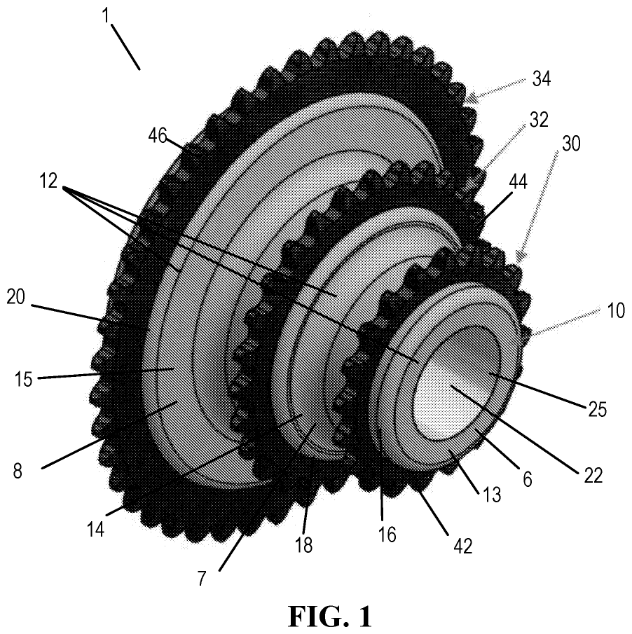

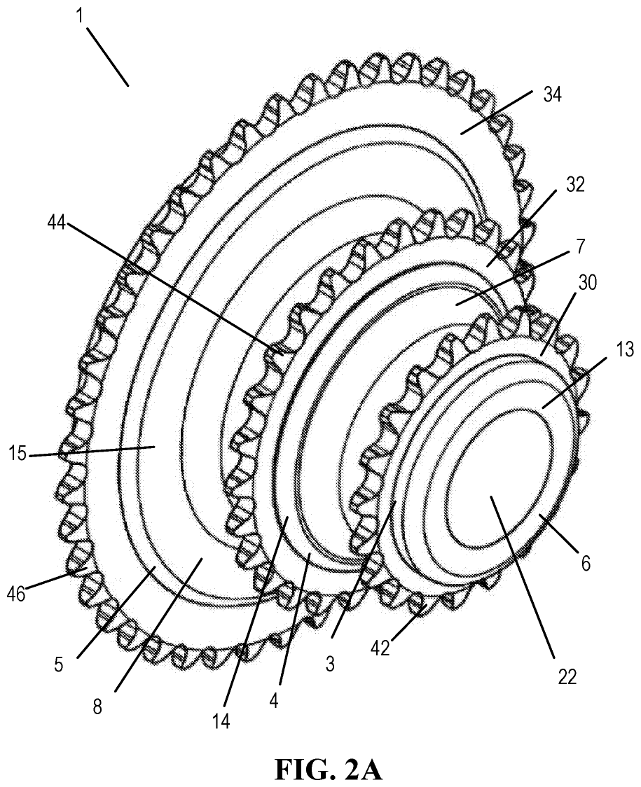

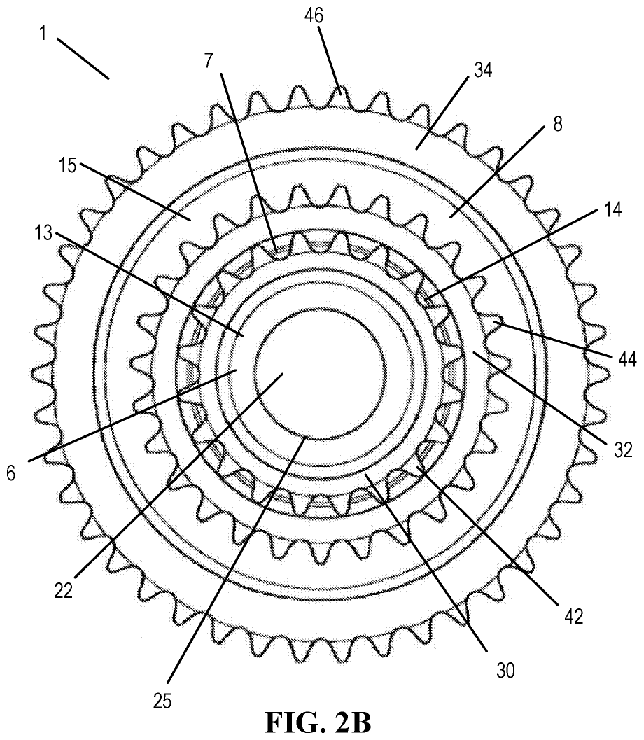

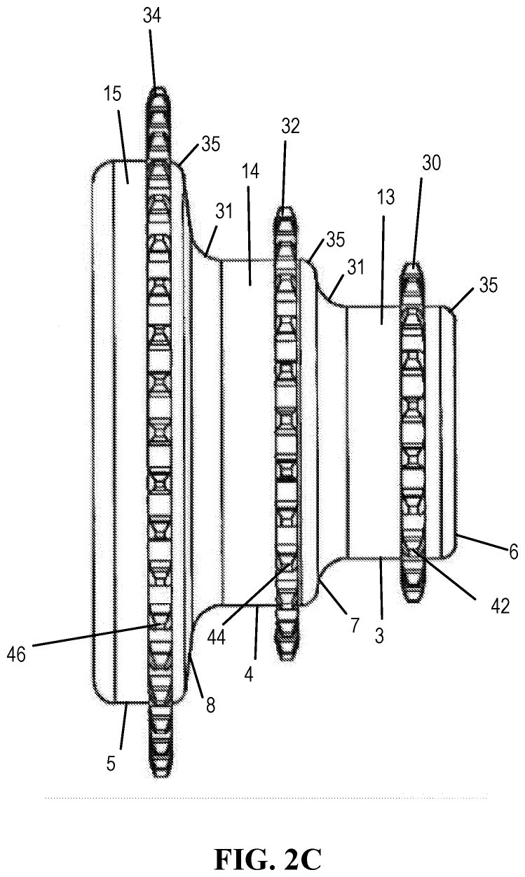

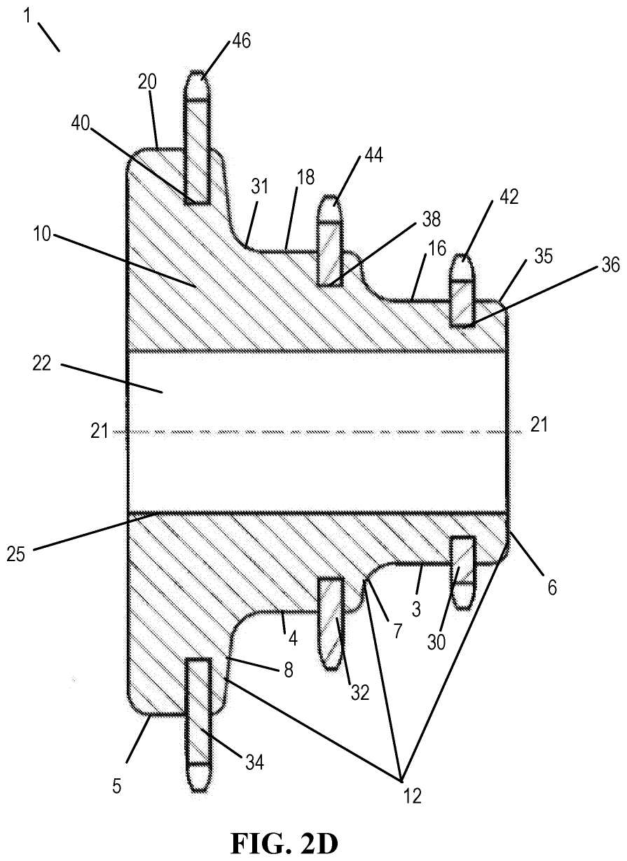

Referring to FIGS. 1 through 2D, the co-molded sprocket assembly 1 includes a sprocket body 10 with a stepped profile 12 of steps, for example three steps 13, 14, 15. Each step 13, 14, 15 is formed of a flat portion 3, 4, 5 having a first outer circumference connected to another flat portion 3, 4, 5 of another or second outer circumference through a transition portion 6, 7, 8. Therefore, each step consists of a flat portion 3, 4, 5 and a transition portion 6, 7, 8. The flat portions 3, 4, 5 transition or connect to the transition portions 6, 7, 8 at a substantially 90 degree angle, and the transition or connection (see transitions 31, 35 in FIGS. 2C and 2D) between the portions may be curved, as shown in the figures, or angled. The transitions 31, 35 may be round, edged, or have a different geometry. While the transition portions 6, 7, 8 are shown at a substantially 90 degree angle in the figures, the transition portions 6, 7, 8 alternatively have a different angle that is not necessarily a straight line. For example, the angle may be a spline, depending on the application. The sprocket body 10 is preferably made of aluminum. In other embodiments, the sprocket body 10 is made of plastic.

The flat portion 3, 4, 5, of each step 13, 14, and 15, has a different outer circumference 16, 18, 20, respectively. The flat portion 3 of step 13 has the smallest outer circumference 16, the flat portion 4 of step 14 has an intermediate outer circumference 18 and the flat portion 5 of step 15 has the largest outer circumference 20. While the figures show a stepped profile where steps 13, 14, and 15 have different circumferences, in other embodiments, one or more of the steps 13, 14, or 15 is not needed because one or more of the sprockets 30, 32, 34 have the same circumference.

The bore 22 extends from a first end to a second end of the body and can receive a shaft rotatable upon a central rotational axis 21 (shown in FIG. 2D) for transmitting torque from the shaft of the engine to the sprocket body 10. The bore 22 of the sprocket body 10 has a uniform inner circumference 25. The uniform inner circumference 25 of the bore 22 depends on the application.

The sprocket assembly 1 also includes three sprockets 30, 32, 34, which each include a plurality of teeth 42, 44, 46, that engage with the links of a chain or toothed belt (not shown). The sprockets 30, 32, 34 are preferably made of steel. In other embodiments, the sprockets 30, 32, 34 are made of powder metal. Each flat portion 3, 4, 5 of the steps 13, 14, 15 of the sprocket body 10 is sized to have an outer circumference 16, 18, 20 larger than an inner circumference 36, 38, 40 (shown in the cross-sectional view of FIG. 2D) of the sprockets 30, 32, 34, respectively. As discussed above, in alternative embodiments, two or more of the sprockets 30, 32, 34 are the same size. Each sprocket member 30, 32, 34 is co-molded into the flat portion 3, 4, 5 of the steps 13, 14, 15 of the sprocket body 10, respectively, such that the annular body of the sprocket members 30, 32, 34 is integrally joined to the sprocket body 10 and at least the plurality of teeth of the sprocket members 30, 32, 34 are external to the sprocket body 10. As a result, a portion of the sprockets 30, 32, 34, including at least the sprocket teeth 42, 44, 46 are located outside the outer circumference 16, 18, 20 of the sprocket body steps 13, 14, 15. The sprocket body 10 transfers torque between the bore 22 and the steel sprockets 30, 32, 34 and joins the sprockets 30, 32, 34 into a single co-molded assembly 1. The sprocket body 10 also provides strength to the sprocket assembly 1.

FIGS. 1A through 2D show three different size sprockets 30, 32, 34. In other embodiments, the co-molded assembly may include different variations and combinations of sprockets 30, 32, 34. As some examples, in other embodiments, the co-molded assembly may include only sprockets 32 and 34. In still other embodiments, the co-molded assembly may include two sprockets 30.

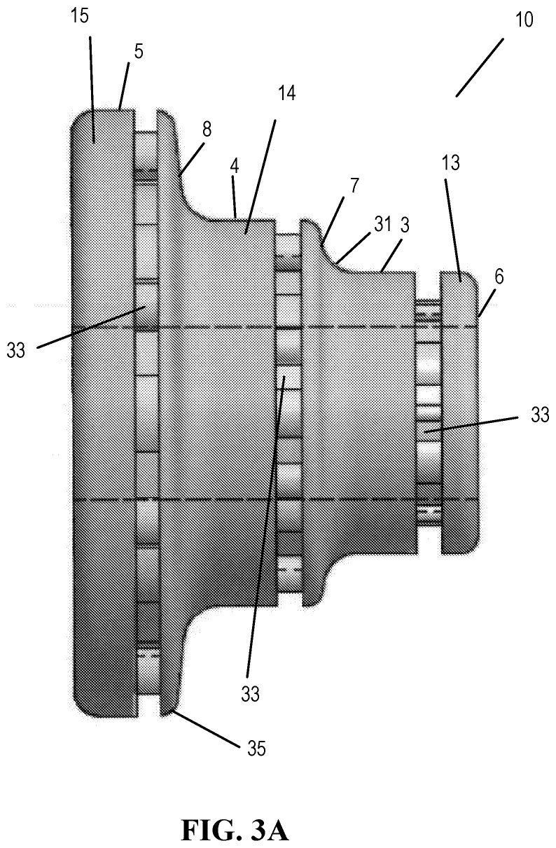

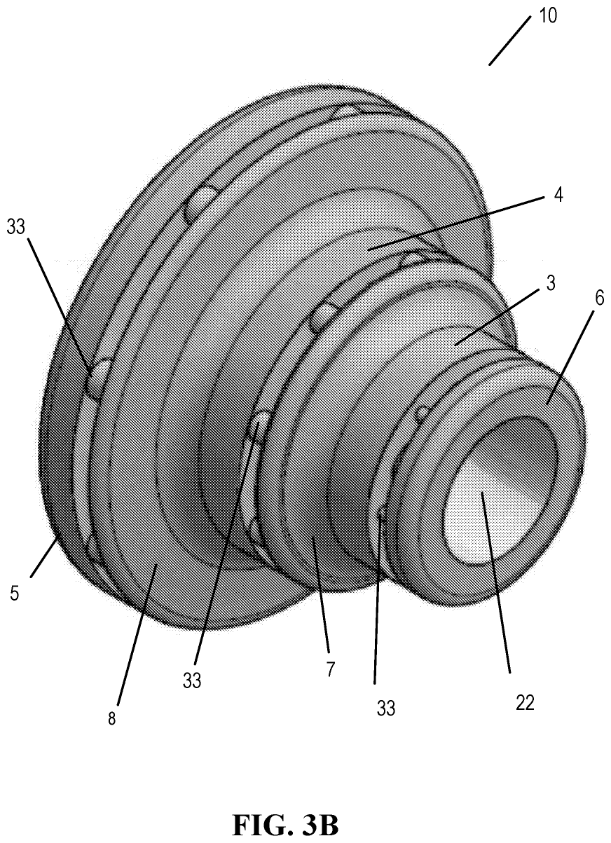

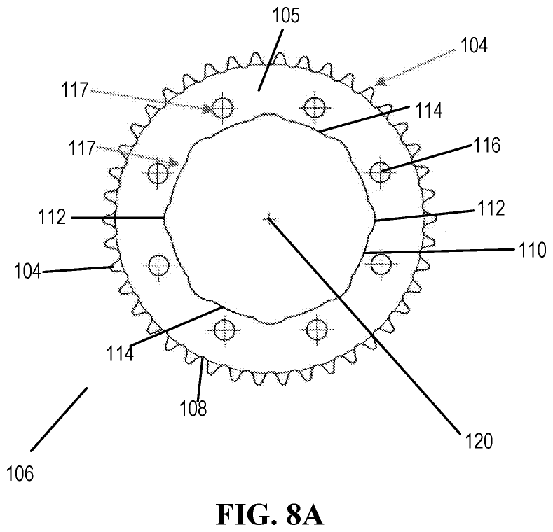

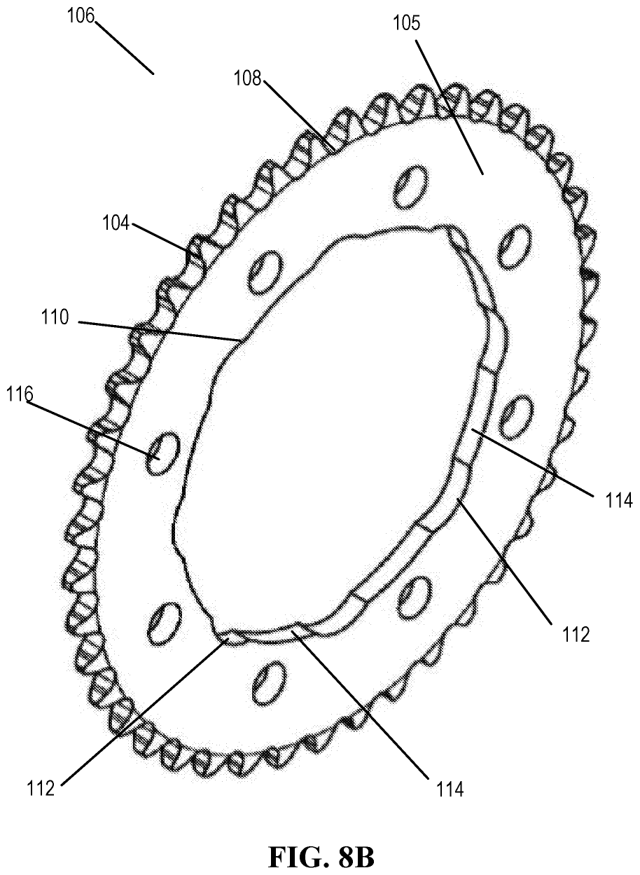

FIGS. 3A and 3B show a sprocket body 10 after co-molding, with the sprockets 30, 32, 34 removed for clarity. As shown in these figures, when the aluminum sprocket body 10 is co-molded with the steel sprockets 30, 32, 34, aluminum fills in 33 the holes 116 in the sprockets 30, 32, 34. During co-molding, the aluminum follows the internal shape 117 (see FIGS. 8A and 8B) of the sprockets 30, 32, 34.

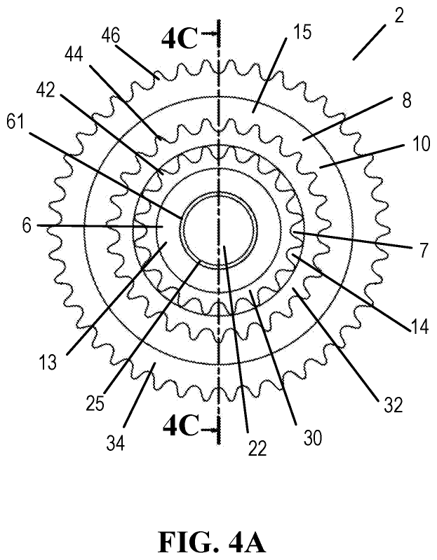

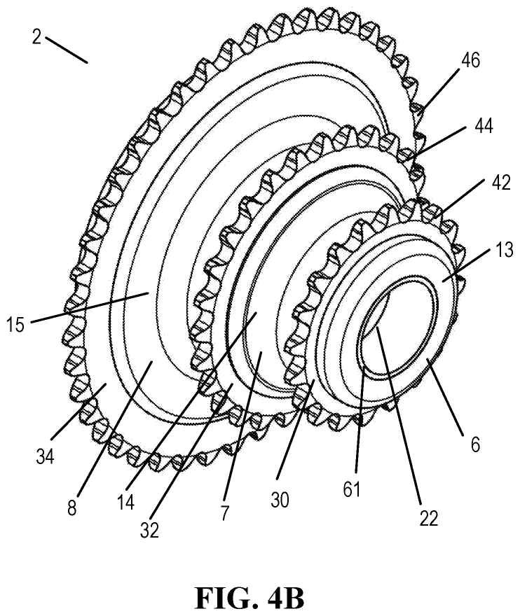

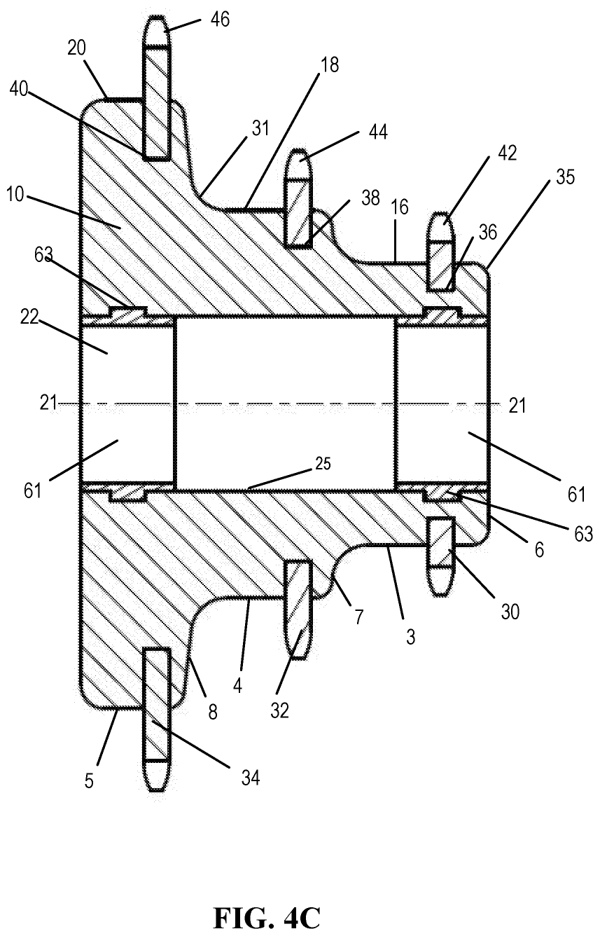

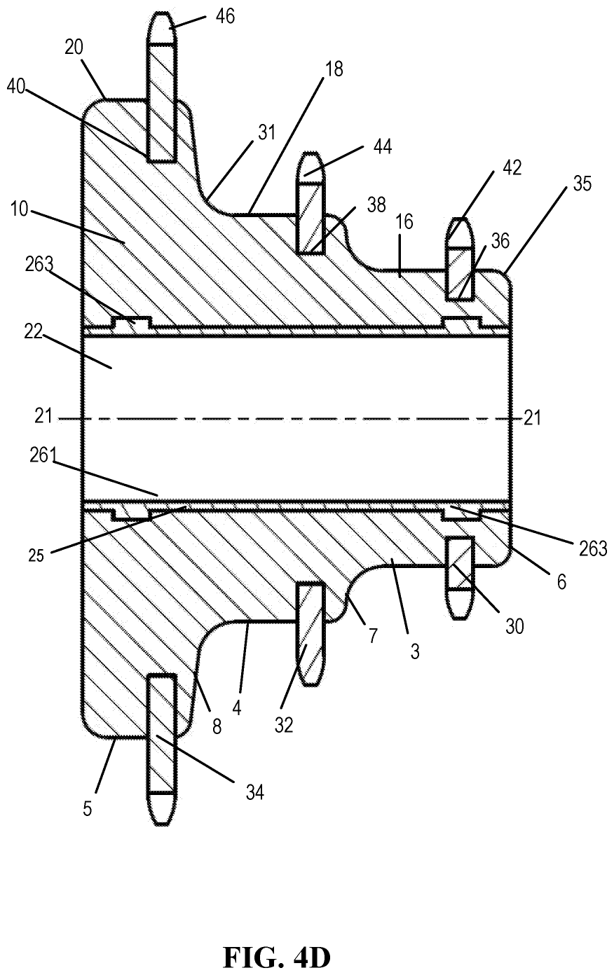

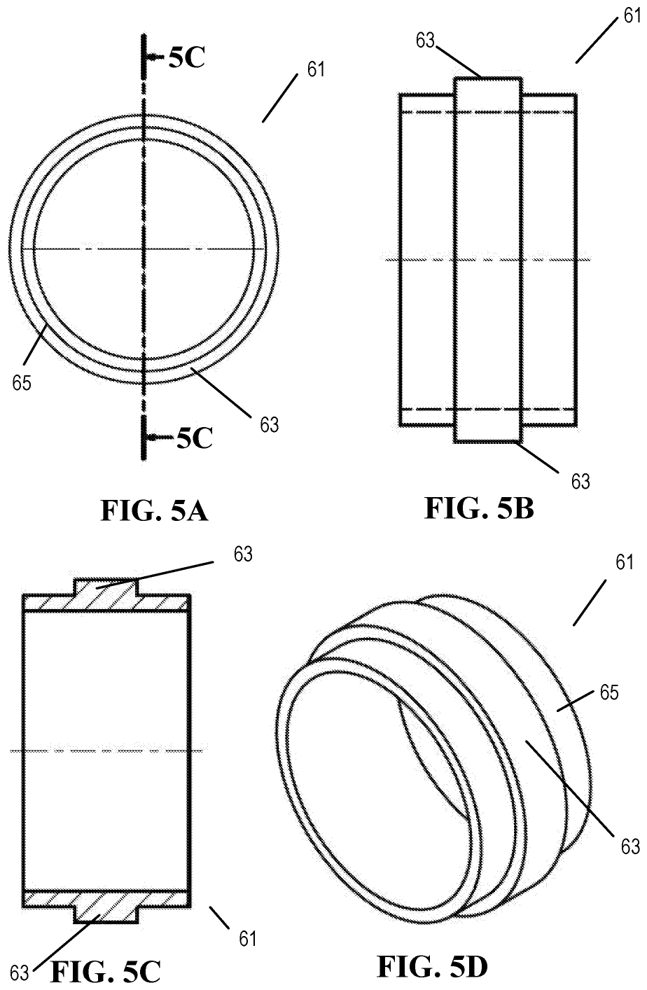

In other embodiments, the co-molded sprocket assembly includes an insert, preferably made of steel. FIGS. 4A through 5D show a sprocket assembly 2 with a stepped profile 12, three sprockets 30, 32, 34, a sprocket body 10 and inserts 61. The embodiment in FIGS. 4A through 5D differs from the embodiment in FIGS. 1A through 3B in the addition of steel inserts 61 within the inner circumference 25 of the bore 22 and aligned with the sprockets 30, 34. There is preferably at least one steel insert 61 for each sprocket 30, 32, 34 in the sprocket assembly 2. The steel insert 61 is co-molded and shaped to match the sprockets 30, 32, 34. In embodiments with cylindrical sprockets, the steel inserts 61 are preferably cylindrical, and include a protrusion 63, which is aligned with the sprocket members 30, 34 and located along the outer circumference 65 of the inserts. Although only two steel inserts 61 are shown in the Figures for clarity, there is preferably also one or more steel inserts 61 aligned with sprocket 32. Steel inserts 61 may be optionally included in any co-molded sprocket assembly described herein. The steel inserts reduce the wear of the inner circumference 25 of the body 10 and thus increase the life of the component. It should be noted that the position of the steel inserts 61 may vary from the positions shown in the Figures in order to optimize stress and wear. The steel inserts can also reduce material stress of the body 10 in the cases of high load and reduce or prevent material deformation of the body 10.

In an alternate embodiment, FIG. 4D shows the co-molded sprocket assembly which includes a single insert 261, preferably made of steel which extends the length of the inner circumference 25 of the bore 22. The steel insert 261 is co-molded and shaped to match the sprockets 30, 32, 34. In embodiments with cylindrical sprockets, the steel insert 261 is preferably cylindrical, and includes at least one protrusion 263, which is aligned with the sprocket members 30, 34 and located along the outer circumference 65 of the inserts. The single steel inserts 261 may be optionally included in any co-molded sprocket assembly described herein. The steel insert 261 may act as a busing to absorb axially clamping load.

Although three steps 13, 14, and 15 are shown in the embodiments of FIGS. 1A through 5D, other numbers of steps corresponding to a different number of sprockets 30, 32, 34 are alternatively possible. For example, if the sprocket assembly includes two sprockets, the sprocket body could have two steps. If the sprocket assembly includes only one sprocket, the body does not include a stepped profile. If the sprocket assembly includes N sprockets, the sprocket body includes up to N steps. Some of the steps may include multiple sprockets in some embodiments. In preferred embodiments, the sprocket assembly has between one and six sprockets. In still other embodiments, the sprocket assembly could include two or more sprockets of the same circumference, without the stepped profile.

Similarly, although three sprockets 30, 32, 34 are shown FIGS. 1A through 5D, a single sprocket, two sprockets, or three or more sprockets are also possible. In addition, while the sprocket body and sprockets are shown with a stepped profile in the figures above, two or more of the sprockets may have the same circumference.

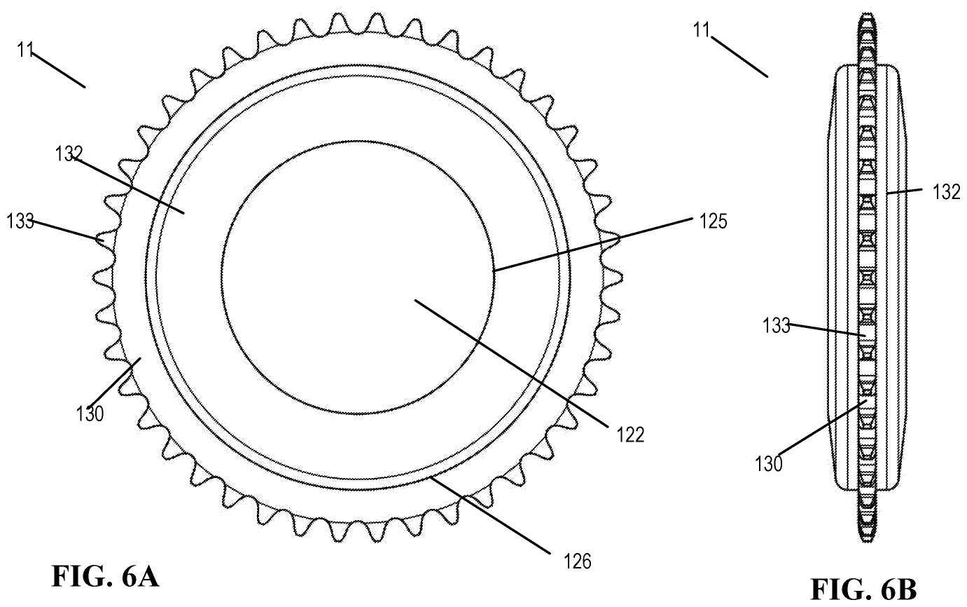

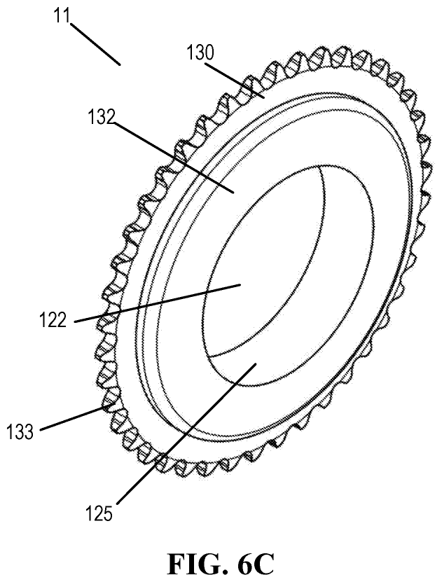

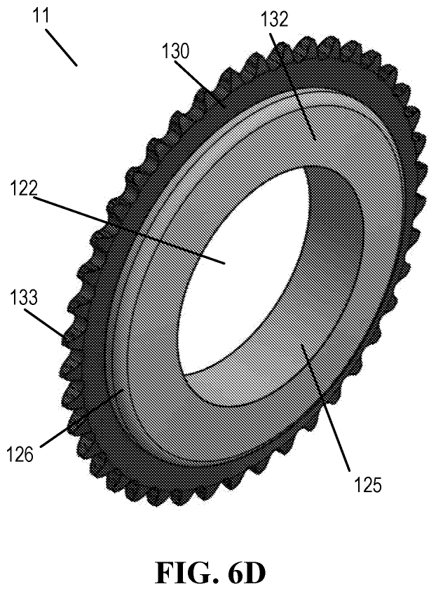

FIGS. 6A through 6D show a co-molded sprocket assembly 11 with a single sprocket 130 having a plurality of teeth 133. Since there is only a single sprocket 130, the sprocket body 132 does not have a stepped profile in this embodiment. Instead, the entire sprocket body 132 has a single outer circumference 126, and a bore 122 with an inner circumference 125. The sprocket member 130 is co-molded into the sprocket body 132 such that the annular body of the sprocket member 130 is integrally joined to the sprocket body 132 and at least the plurality of teeth 133 of the sprocket member 130 are external to the sprocket body 132. As a result, a portion of the sprocket 130 including at least the sprocket teeth 133 are located outside the outer circumference 126 of the sprocket body 132. The sprocket body 132 is preferably made of aluminum. In other embodiments, the sprocket body 132 is made of plastic. The sprocket 130 is preferably made of steel or powder metal. The sprocket body 132 transfers torque between the bore 122 and the steel sprocket 130. The sprocket body 132 also provides strength to the sprocket assembly 11.

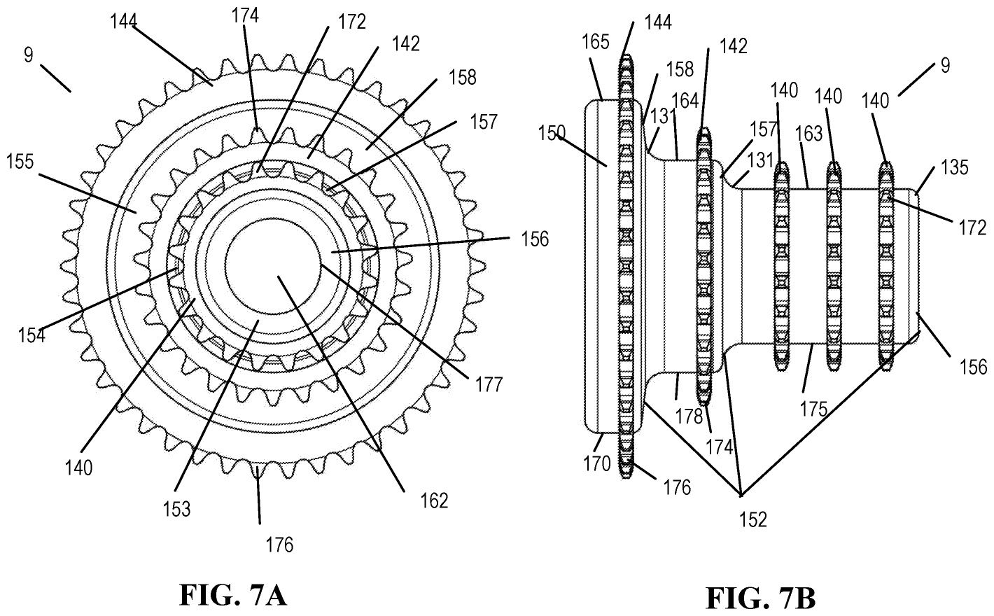

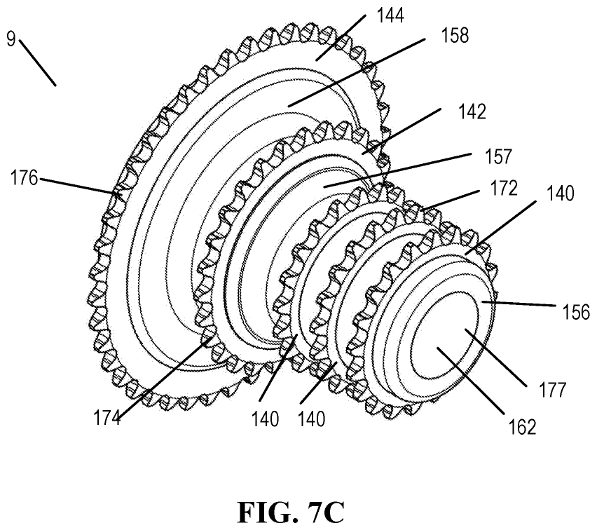

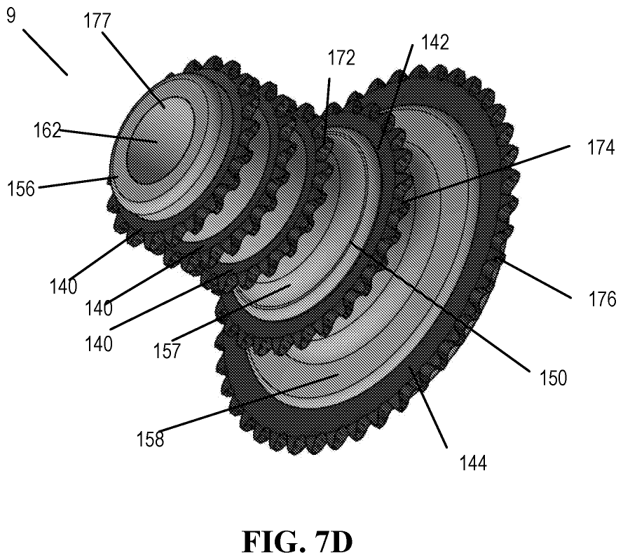

FIGS. 7A through 7D show a co-molded sprocket assembly 9 with five sprockets 140, 142, 144, and a sprocket body 150. Three of the sprockets 140 are the same size, while the other two sprockets 142, 144 are progressively larger. As a result, the sprocket body 150 has a stepped profile 152 of three steps 153, 154, 155. Each step 153, 154, 155 is formed of a flat portion 163, 164, 165 having a first outer circumference connected to another flat portion 163, 164, 165 of another or second outer circumference through a transition portion 156, 157, 158. Therefore, each step consists of a flat portion 163, 164, 165 and a transition portion 156, 157, 158. The flat portions 163, 164, 165 transition or connect to the transition portions 156, 157, 158 at a substantially 90 degree angle, and the transition or connection (see transitions 131, 135 in FIG. 7B) between the portions may be curved, as shown in the figures, or angled. The transitions 131, 135 may be round, edged, or have a different geometry. While the transition portions 156, 157, 158 are shown at a substantially 90 degree angle in the figures, the transition portions 156, 157, 158 alternatively have a different angle that is not necessarily a straight line. For example, the angle may be a spline, depending on the application. The sprocket body 150 is preferably made of aluminum. In other embodiments, the sprocket body 150 is made of plastic.

The flat portion 163, 164, 165, of each step 153, 154, and 155, has a different outer circumference 175, 178, 170, respectively. The flat portion 163 of step 153 has the smallest outer circumference 175, the flat portion 164 of step 154 has an intermediate outer circumference 178 and the flat portion 165 of step 155 has the largest outer circumference 170.

The bore 162 extends from a first end to a second end of the body and can receive a shaft rotatable upon a central rotational axis (shown in FIG. 2D) for transmitting torque from the shaft of the engine to the sprocket body 150. The bore 162 of the sprocket body 150 has a uniform inner circumference 177. The uniform inner circumference 177 of the bore 162 depends on the application.

The sprocket assembly 9 also includes five sprockets 140, 142, 144, which each include a plurality of teeth 172, 174, 176, that engage with the links of a chain or toothed belt (not shown). The sprockets 140, 142, 144 are preferably made of steel. In other embodiments, the sprockets 140, 142, 144 are made of powder metal. Each flat portion 163, 164, 165 of the steps 153, 154, 155 of the sprocket body 150 is sized to have an outer circumference 175, 178, 170 larger than an inner circumference of the sprockets 140, 142, 144, respectively. Each sprocket member 140, 142, 144 is co-molded into the flat portion 163, 164, 165 of the steps 153, 154, 155 of the sprocket body 150, respectively, such that the annular body of the sprocket members 140, 142, 144 is integrally joined to the sprocket body 150 and at least the plurality of teeth of the sprocket members 140, 142, 144 are external to the sprocket body 150. As a result, a portion of the sprockets 140, 142, 144, including at least the sprocket teeth 172, 174, 176 are located outside the outer circumference 176, 178, 170 of the sprocket body steps 153, 154, 155. The sprocket body 150 transfers torque between the bore 162 and the steel sprockets 140, 142, 144 and joins the sprockets 140, 142, 144 into a single co-molded assembly 9. The sprocket body 150 also provides strength to the sprocket assembly 9.

The inserts 61 shown in FIGS. 4A through 5D could be included in either of the embodiments shown in FIGS. 6A through 7D.

In alternative embodiments, the sprocket assembly may include any number of sprockets, including, but not limited to, one, two, three, four, or more than four sprockets. In addition, the co-molded sprocket assembly may include a stepped profile, where two or more of the sprockets have a different circumference. Inserts may also be included in these alternative embodiments.

FIGS. 8A and 8B show a sprocket 106 separate from a sprocket body. The sprocket 106 is preferably made of steel. The sprocket 106 includes an annular body or base 105 and a plurality of teeth 104 along an outer circumference 108 of the sprocket 106. The sprocket 106 also includes a plurality of holes 116 and a patterned inner circumference 110. While the holes 116 are shown as round in the Figures, other geometry for the holes, including, but not limited to, square, rectangular, oval, or a complex shape could be used. In FIGS. 8A and 8B, the pattern includes eight semi-circular indentations 112 extending towards the outer circumference and evenly spaced apart from each other by a smooth circumferential section 114. The eight holes 116 are located on the base 105 adjacent to the smooth circumferential sections 114. While eight indentations 112 and eight holes 116 are shown in the figures, other numbers, shapes and sizes of the indentations 112 and holes 116 are also possible. For example, any geometry other than a circle is an option to transfer the torque. In this way, the indentations could be square, rectangular, oval or any complex shape, limited by the space available and the amount of torque that needs to be transferred. A central rotational axis 120 is also shown in FIG. 8A.

The sprocket 106 has an internal geometry to effectively transfer torque. The internal shape is irregular in that it does not have a single uninterrupted circular circumference. The internal shape 117 of the sprocket 106 and the hole 116 transfer the torque from a shaft within the bore of the sprocket body to the sprocket teeth 104. The sprocket teeth 104 transfer the torque to a chain or toothed belt (not shown). The sprocket body 10, 132, 150 (shown in the earlier figures) transfers the torque between the shaft received by the bore and the sprocket 106.

The sprocket 106 could be used as any of the sprockets 30, 32, 34, 130, 140, 142, 144 shown in the figures described herein.

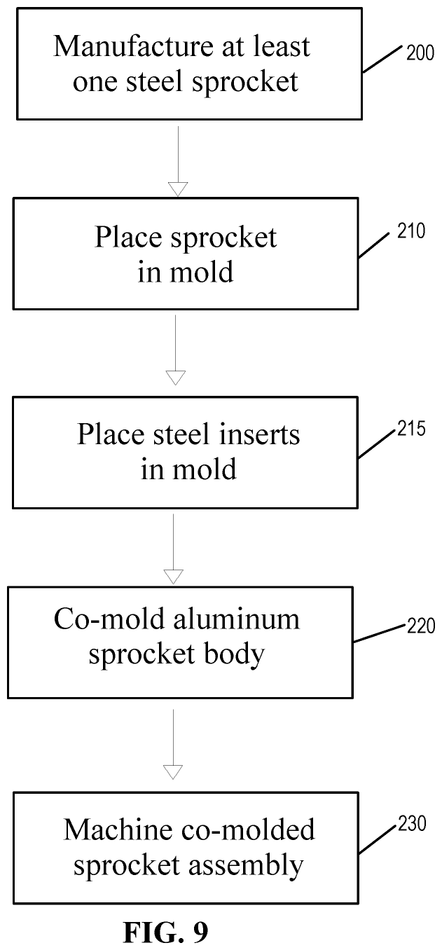

In a preferred method shown in FIG. 9, the sprockets, which are preferably made of steel or powder metal, are preferably manufactured, for example using a fineblanking process, in step 200. Alternatively, electroerosion (EDM) may be used. In embodiments using powder metal, a sintering process may alternatively be used.

Once the steel sprockets have been made, they are put in an aluminum molding in step 210. Optionally, in embodiments with steel inserts, steel inserts aligned with the sprockets are also put into the mold in step 215. The aluminum sprocket body is then co-molded with the steel sprockets (and the optional steel inserts) in step 220. In this step, the sprocket body is cast, preferably using aluminum. The sprocket assembly is then machined to its final specifications in step 230.

While certain embodiments of a sprocket assembly are shown in the figures, in other embodiments, the sprocket assembly may have a different housing sprocket geometry, steel sprocket geometry, dimensions and shape of the sprockets and the sprocket body, number of steel sprockets, material type, and/or a different the steel sprocket process could be used.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A sprocket assembly for engaging a chain or a toothed belt, comprising:
a) a sprocket body forming a bore extending from a first end of the sprocket body to a second end of the sprocket body, the sprocket body having a rotational center axis extending through the bore; and
b) at least one sprocket member co-molded with an outer circumference of the sprocket body, positioned to rotate around the rotational center axis extending through the bore, wherein the sprocket member comprises an annular body with a plurality of teeth along an outer circumference of the sprocket member to engage with the chain or toothed belt.

2. The sprocket assembly of claim 1, wherein at least three sprocket members are co-molded within the outer circumference of the sprocket body.

3. The sprocket assembly of claim 2, wherein the sprocket body comprises three steps, each of the steps being formed on the outer circumference of the sprocket body and comprising a flat portion connected to a transition portion, and each flat portion of the steps having a different outer circumference, wherein each sprocket member is co-molded into the flat portion of the steps of the sprocket body, such that the annular body of each sprocket member is integrally joined to the sprocket body and at least the plurality of teeth of each sprocket member are external to the sprocket body.

4. The sprocket assembly of claim 1, wherein the annular body of the sprocket member comprises a plurality of semi-circular protrusions extending away from the rotational central axis, the semi-circular protrusions being evenly spaced apart from each other.

5. The sprocket assembly of claim 4, wherein the annular body of the sprocket member comprises eight semi-circular protrusions extending away from the rotational central axis.

6. The sprocket assembly of claim 4, wherein the annular body of the sprocket member has a plurality of evenly spaced holes.

7. The sprocket assembly of claim 1, further comprising at least one steel insert that fits into the bore of the sprocket body and is aligned with the at least one sprocket member.

8. The sprocket assembly of claim 1, wherein the sprocket member is made of steel and the sprocket body is made of aluminum.

9. A sprocket assembly for engaging a chain or a toothed belt, comprising:
a) a sprocket body forming a bore extending from a first end of the sprocket body to a second end of the sprocket body, the sprocket body having a rotational center axis extending through the bore, wherein the sprocket body comprises three steps, each of the steps being formed on an outer circumference of the sprocket body and comprising a flat portion connected to a transition portion, and each flat portion of the steps having a different outer circumference;
b) at least one first sprocket member positioned to rotate around the rotational center axis, comprising a first annular body with a first plurality of teeth along a first outer circumference of the first sprocket member to engage with the chain or toothed belt, wherein the first sprocket member is co-molded into a first flat portion of a first step of the sprocket body, such that the first annular body of the first sprocket member is integrally joined to the sprocket body and at least the first plurality of teeth of the first sprocket member are external to the sprocket body;
c) at least one second sprocket member positioned to rotate around the rotational center axis, comprising a second annular body with a second plurality of teeth along a second outer circumference of the second sprocket member to engage with the chain or toothed belt, wherein the second sprocket member is co-molded into a second flat portion of a second step of the sprocket body, such that the second annular body of the second sprocket member is integrally joined to the sprocket body and at least the second plurality of teeth of the second sprocket member are external to the sprocket body; and
d) at least one third sprocket member positioned to rotate around the rotational center axis, comprising a third annular body with a third plurality of teeth along a third outer circumference of the third sprocket member to engage with the chain or toothed belt, wherein the third sprocket member is co-molded into a third flat portion of a third step of the sprocket body, such that the third annular body of the third sprocket member is integrally joined to the sprocket body and at least the third plurality of teeth of the third sprocket member are external to the sprocket body.

10. The sprocket assembly of claim 9, wherein the annular bodies of the sprocket members comprise a plurality of semi-circular protrusions extending away from the rotational central axis, the semi-circular protrusions being evenly spaced apart from each other.

11. The sprocket assembly of claim 10, wherein the annular bodies of the sprocket members comprise eight semi-circular protrusions extending away from the rotational central axis.

12. The sprocket assembly of claim 10, wherein the annular bodies of the sprocket members have a plurality of evenly spaced holes.

13. The sprocket assembly of claim 9, further comprising at least one steel insert that fits into the bore of the sprocket body and is aligned with at least one of the sprocket members.

14. The sprocket assembly of claim 9, wherein the sprocket members are made of steel and the sprocket body is made of aluminum.

15. A method of making a sprocket assembly comprising an aluminum sprocket body forming a bore extending from a first end of the sprocket body to a second end of the sprocket body, the sprocket body having a rotational center axis extending through the bore, and at least one steel sprocket member co-molded with an outer circumference the sprocket body, positioned to rotate around the rotational center axis, wherein the sprocket member comprises an annular body with a plurality of teeth along an outer circumference of the sprocket member to engage with the chain or toothed belt, comprising the steps of:
a) manufacturing the steel sprocket member;
b) positioning the steel sprocket member in a mold for the aluminum sprocket body; and
c) molding the aluminum sprocket body to the steel sprocket member.

16. The method of claim 15, wherein the steel sprocket member is manufactured using a fineblanking process.

17. The method of claim 15, further comprising, before the step of molding the aluminum sprocket body to the steel sprocket member, the step of positioning at least one steel insert into the mold such that the at least one steel insert is aligned with the at least one sprocket member.

18. (canceled)

19. (canceled)

20. (canceled)
